(19) United States
(12) Patent Application Publication
(10) Pub. No.: US 2012/0026840 A1
(43) Pub. Date: Feb. 2, 2012

(54) WRISTWATCH

(75) Inventor: Leonardo Foschi, San Miniato (Pisa) (IT)

(73) Assignee: Roberto BARDELLI, Uzzano (Pistoia) (IT)

(21) Appl. No.: 13/257,508

(22) PCT Filed: Mar. 18, 2010
(86) PCT No.: PCT/IB10/51171

§ 371 Date: Oct. 21, 2011

(30) Foreign Application Priority Data
Mar. 20, 2009 (IT) FI2009A000054

(51) Int. Cl. G04C 17/00; G04B 19/24; G04C 3/00

(52) U.S. Cl. 368/28; 368/88

(57) ABSTRACT

A wristwatch comprising a case (2) housing a display dial (4a) protected by a transparent screen (3), a timing unit adapted to emit a digital time signal, and electrical feeding means (10) for the timing unit. The watch further comprises: magnetic attraction means (5), fed by the electric feeding means (10); time display means (6) freely arranged on the dial (4a) and movable thereon under the action and as a function of the magnetic attraction means (5); and control means adapted to convert at least the time signal retrieved from the timing unit in a control signal of the magnetic attraction means (5).

### TECHNICAL FIELD OF THE INVENTION

The present invention concerns the field of the wristwatches, and namely it regards a watch adapted to display in a novel fashion the time and possibly other data, signs or information.

### BACKGROUND OF THE INVENTION

The above mentioned field, as known, is subject to a strong and relentless research activity, the aim of which is to retrieve new solutions satisfying the always changing needs of a vast and demanding public. Said research considers the functional aspects of the watch, without however disregarding the aesthetical factors, which are in fact of primary importance in a product which is also and in particular a fashion accessory, besides of a powerful status symbol.

### SUMMARY OF THE INVENTION

The object of the present invention is thus to provide a new wristwatch which combines, in a completely novel and surprisingly effective manner, high technology advanced functional aspects with an outstanding aesthetical characterization.

This and other objects are accomplished by the wristwatch according to the invention, the essential characteristics of which are defined by the attached claim 1.

### BRIEF DESCRIPTION OF THE DRAWINGS

The characteristics and advantages of the wristwatch according to the present invention shall become clearer from the following description of an embodiment thereof, given as an example and not for limiting purposes, with reference to the attached drawings, in which:

FIG. 1 schematically represents an exploded view of a wristwatch according to the invention, with parts omitted for the sake of clarity;

FIG. 2 is a longitudinal section view of the watch of FIG. 1, that is a sectional view on a plane orthogonal with the central axis of the bracelet when the same is wound in a ring-like fashion around the wrist of a user; and

FIG. 3 is a different perspective view of the watch, with further details represented and the case omitted, in a use configuration with the time displayed on the dial.

### DESCRIPTION OF A PREFERRED EMBODIMENT

With reference to the above figures, a watch according to the present invention comprises a bracelet 1 and a case 2, generally designed according to any fashion and/or technical solution of a known kind.

In a likewise conventional manner, the case 2 has a wide opening 2a, circular in this case, shut by a screen 3 made of a transparent material such as scratch-proof glass. On the opposite side, intended to make contact with the skin of the user, the case 2 is shut by a bottom plate 9. The case houses the so called “movement” of the watch, not shown, featuring a conventional quartz timing unit with a digital output signal. Above the movement, close to the screen 3 though spaced from it, a plate 4 defines the dial 4a of the watch, that is the surface on which one can read, in particular but not exclusively, the time.

According to the invention, a magnetic attraction system is arranged under the plate 4, comprising a slab 5 internally partitioned in a plurality of cells made of a ferromagnetic material mutually separated by a net of an amagnetic material (i.e. permeable to magnetism and not magnetizable), typically according to an orthogonal Cartesian grid. The cells, via an excitation electrical system of a type per se known, are made capable of exerting a magnetic attraction, in a mutually independent and selective manner. The excited cells correspond to respective surface portions of the plate 4, in turn made of an amagnetic material, and in said portions the magnetic attraction becomes selectively concentrated, while the attraction remains absent in the remaining cells.

Movable means or members (movable according to at least one degree of freedom) responsive to the magnetic attraction exerted by the cells of the slab 5 are arranged over the dial 4a. In the depicted embodiment, and according to a preferred solution, such movable means take the fashion of granular members 6, each comprising in particular a precious gem 61 supported by a mounting 62, made of a ferromagnetic material, which defines the support basis of the stone on the dial 4a and in contact therewith.

As an alternative, according to a different embodiment not shown, the movable means may be normal hands at least partially made of a ferromagnetic material and freely pivotable, when attracted by the magnetic attraction force, around a central support pin protruding from the dial 4a.

The magnetic attraction means and the timing unit are wired to a programmable control unit (in turn not represented), typically a microchip printed circuit board, adapted to, among other functions, to convert the digital signal outputted by the timing unit in an input control signal to the magnetic attraction means, or more precisely to the relative excitation system, the input control signal comprising information on which among the cells of the slab 5 must be made attractive, as a function of the current outputted time.

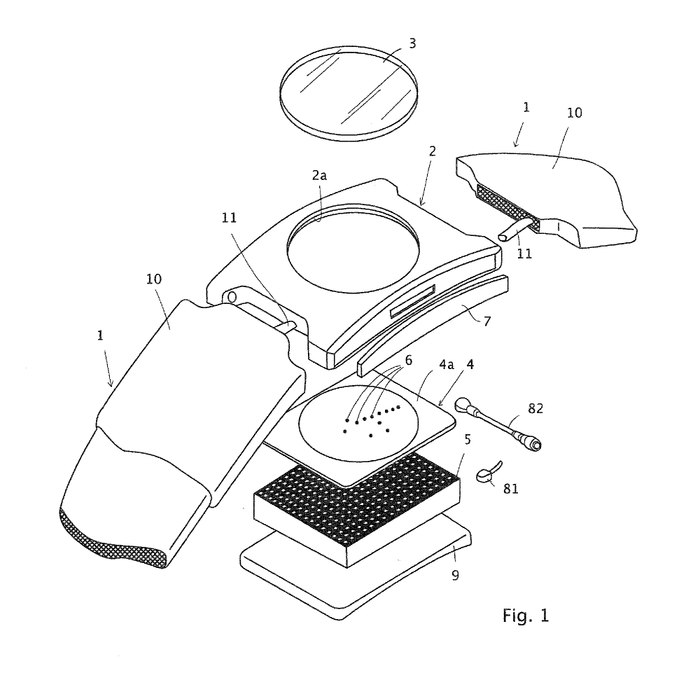

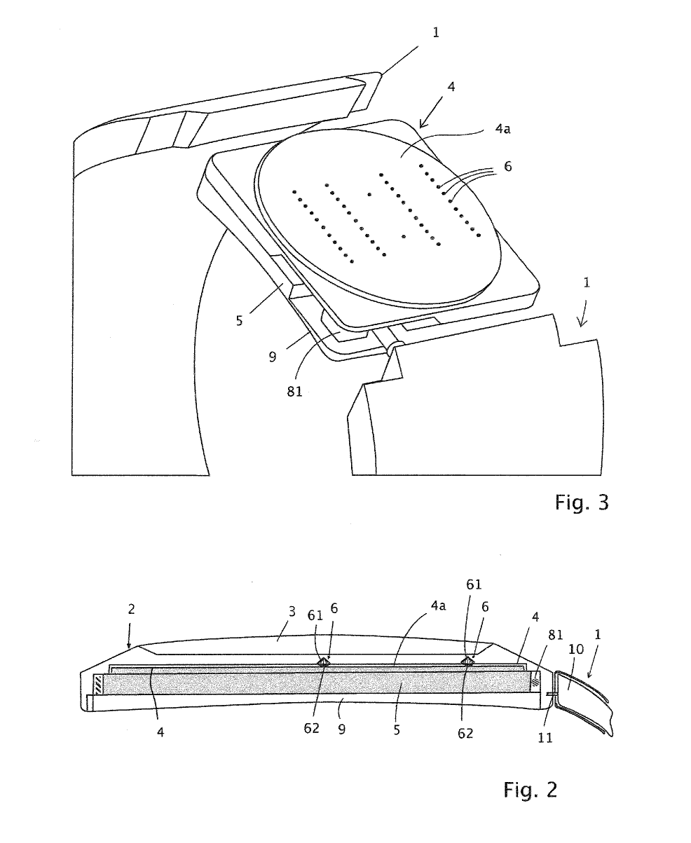

A switch is provided for turning on and off the electric excitation, and consequently the magnetic attraction. The switch may comprise a press button 7 to be manually operated on a side of the case 2, or an inertial device making use of an acceleration sensor, to be operated simply by strongly and swiftly shaking the arm on the wrist of which the watch is worn. Two alternative examples of acceleration sensors are represented in FIG. 1, indicated at 81 and 82. Miniaturized acceleration sensor that can be used to this purpose are e.g. those marketed by the US company DYTRAN INSTRUMENTS INC. (www.dytran.com).

The watch finally comprises energy feeding means such as typically battery means 10, advantageously arranged in housings formed in the bracelet 1 at one or both the ends adjacent with the case 2. Clearly, the battery means 10 feed, via wires 11, besides the timing unit as in known watches, the magnetic attraction means (and specifically the electric excitation system), the acceleration sensors if present, and the control unit.

The operation of the watch according to the invention will be immediately apparent from the foregoing description. In a normal condition, the granular members 6 will be free to move in the space between the transparent screen 3 and the dial 4a, and the watch will take on the aspect of a simple ornamental accessory, with the additional peculiarity of the gems that can be seen spreading around freely over the dial as the arm of the user swings.

When one wishes to display the time of the day, the manual or inertial switch will be operated. In this way the control unit, once read the digital time output, will activate the selective excitation of a distribution of cells such as to “draw” or compose the time figure, with the gems (or hands) magnetically attracted. The time figure may comprise the hour and minutes in Arabic numerals, as in FIG. 3 the time 11:11, or a hand-like pattern. It goes without saying that, besides to the hour and minutes (and seconds), other type of information may be displayed (date, day of the week, local times of different time zones etc.), or even, more generally speaking, images, patterns or preset graphic or numeric symbols, even to be customized when the watch is purchased (mane of the owner, logos of various kinds etc.).

Once the need for time display ceases, by switching again the switch, or after that a predetermined display period has lapsed, the excitation of the magnetic attraction means will be interrupted, bringing back the gems (or the hands) in the original free condition. Second and further magnetic attraction means may be optionally provided, having an arrangement analogous to the first attraction means described above, adapted to generate a magnetic field opposing the field generated by the first magnetic attraction means, in order to neutralize possible residual and undesired magnetic forces that could disturb a correct visualization. To this purpose, it may even suffice that the magnetic polarity of the same first magnetic field be reversed.

Accordingly, the wristwatch according to the invention fully attains the prefixed object, considering that with a structurally simple solution the result is obtained of arousing the interest of the public, above and beyond for the peculiar functionality, for outstandingly appealing aesthetic contents.

The distribution of selectively magnetizable cells over the slab 5 may be arranged according to different patterns, namely in circular sectors or other patterns, even fancy ones, as a function of the specific display modes one wishes to obtain. More generally, the structure of the magnetic attraction means may vary with respect to the one in the exemplifying embodiment, according to implementation that will be obvious to the skilled person.

According to a further different simplified embodiment, not shown, the same hands of the watch may take the function of the magnetic attraction means, again excited by an electric system, with the granular members that, in this case, have mostly the effect of emphasizing and enriching the legibility of the same hands. In this embodiment, the hands will therefore necessarily have a laminar structure, arranged close to the dial surface 4a of the plate 4, so as to leave room to the movable gems 6. In case of hours with superimposed hands, the exceeding gems that do not find place over the hands can be left free or used, as already mentioned, for designing other patterns. This indeed applies also to the depicted main embodiment, when the number of gems exceeds the number required for displaying a specific time figure. The dial can also be associated with lighting means, so that the light radiation will be diffused by the gems so as to obtain an aesthetical effect even more peculiar and a better readability in poor visibility conditions, such as at night.

The present invention has been described with reference to a preferred embodiment. It should be understood that there can be other embodiments that make use of the same inventive concept, as defined by the scope of the claims attached hereafter.

1. A wristwatch comprising a case housing a display dial protected by a transparent screen, a timing unit adapted to emit a digital time signal, and electrical feeding means for said timing unit, the wristwatch further comprising: magnetic attraction means, fed by said electric feeding means; time display means freely arranged on said dial and movable thereon under the action and as a function of said magnetic attraction means; and control means adapted to convert at least said time signal retrieved from said timing unit in a control signal of said magnetic attraction means.

2. The watch according to claim 1, wherein said magnetic attraction means comprise hands arranged close to said dial, excitable in order to result magnetized and attract said movable display means, the latter comprising a number of granular elements at least partially made up of a ferromagnetic material and arranged between said dial and said transparent screen.

3. The watch according to claim 2, wherein said granular elements are precious or semiprecious gems associated with respective mountings made up of a ferromagnetic material.

4. The watch according to claim 3, wherein said dial is associated with lighting means adapted to light said gems.

5. The watch according to claim 1, wherein said magnetic attraction means comprise a number of regions excitable to be magnetized in a selective and independent manner, said regions corresponding to respective pre-determined surface portions of said dial, said control signal comprising information on a distribution of regions to be selectively excited, the watch further comprising switch means arranged on the feeding of said magnetic means to turn the magnetic excitation on or off; said display means being freely arranged, according to at least one degree of freedom, in order to provide at least a display of the current time.

6. The watch according to claim 5, wherein said display means comprise a number of granular elements at least partially made up of a ferromagnetic material and arranged between said dial and said transparent screen in order to compose said display of the current time in numerals or by forming a pattern of hands.

7. The watch according to claim 6, wherein said granular elements are precious or semiprecious gems associated with respective mountings made up of a ferromagnetic material.

8. The watch according to claim 3, wherein said dial is associated with lighting means adapted to light said gems.

9. The watch according to claim 5, wherein said display means comprise hands at least partially made up of a ferromagnetic material and arranged between said dial and said screen in a freely pivotable manner around to an axis orthogonal to the dial plane.

10. The watch according to claim 5, wherein said magnetic attraction means comprise a slab arranged under said dial or embodied therein, partitioned in a grid of cells, corresponding to said independently and selectively excitable regions.

11. The watch according to claim 10, wherein said cells are made up of a ferromagnetic material and mutually separated by a net of an amagnetic material, the magnetic attraction means further comprising electric excitation means adapted to independently and selectively excite said cells.

12. The watch according to claim 11, wherein said slab is lined with a layer or sheet made up of an amagnetic material, defining said dial and supporting said display means.

13. The watch according to claim 10, wherein said grid is an orthogonal Cartesian grid.

14. The watch according to claim 1, further comprising second magnetic attraction means adapted to generate a magnetic field opposing the field generated by the first magnetic attraction means.

15. The watch according to claim 1, wherein said switch means comprise a manual switch.

16. The watch according to claim 1, wherein said switch means comprise an inertial switch.

17. The watch according to claim 1, wherein said feeding means comprise battery means arranged in at least a housing formed in a bracelet of the watch.

18. The watch according to claim 1, wherein said time signal transmits further information such as date information.

19. The watch according to claim 1, wherein said control means are adapted to provide said magnetic means with further control signals, said further signals comprising further information on the distribution of regions to be selectively excited, said further information referring to predetermined images or graphic o numeric symbols to be displayed on said dial.
